(19) United States
(12) Patent Application Publication
(10) Pub. No.: US 2002/0135757 A1
(43) Pub. Date: Sep. 26, 2002

(54) LCC device inspection module

(75) Inventor: Mark R. Shires, Glendale, WI (US)

Correspondence Address: Daniel S. Jones, Michael Best & Friedrich LLP, 100 East Wisconsin Avenue, Milwaukee, WI, 53202-4108, US

(73) Assignee: Robotic Vision Systems, Inc., Canton, MA (US)

(21) Appl. No.: 10/141,275

(22) Filed: May 7, 2002

Related U.S. Application Data
(63) Continuation-in-part of application No. 10/039,378, filed on Jan. 2, 2002.
(60) Provisional application No. 60/259,297, filed on Jan. 2, 2001.

(51) Int. Cl. G01N 21/00

(52) U.S. Cl. 356/237.1

(57) ABSTRACT

The invention provides an apparatus for inspecting an LCC device. The apparatus can detect a variety of surface defects including small cracks, exposed copper, and peripheral deformities on the LCC device. The apparatus includes an LCC support mechanism adapted to support the LCC device, a camera positioned to view the LCC device, and a plurality of light sources that emit light to illuminate the LCC device.

### BACKGROUND

This application is a continuation-in-part of U.S. application Ser. No. 10/039,378, filed Jan. 2, 2002, which claims the benefit of U.S. Provisional Patent Application No. 60/259,297, filed Jan. 2, 2001.

The invention relates to machine vision systems and more particularly to a machine vision system adapted to inspect leadless chip carrier (“LCC”) devices for quality control purposes. LCC devices are different from electronic devices having leads in that the LCC devices include pads which are typically made of copper and completely covered with solder. The pads are arranged on the bottom of an LCC device but do not extend significantly from the main body of the LCC device.

### SUMMARY

The invention provides an apparatus for inspecting an LCC device. The apparatus can detect surface defects, exposed copper and peripheral deformities on the LCC device. The apparatus includes an LCC support mechanism adapted to support the LCC device, a camera positioned to view the LCC device along a line of sight, and a light source that emits light to illuminate the LCC device in a substantial hemisphere of light except along the line of sight. This type of lighting is helpful, for example, in detecting cracks in the LCC device because the light is unable to shine into the cracks and the cracks appear as thin shadows on the LCC device.

The apparatus may also include a first light source that emits light having a first frequency that is reflected by copper and a second light source that emits light having a second frequency that is not reflected by copper to the extent of the first frequency. The camera can be positioned to view a first image of the LCC device illuminated by the first light source and to view a second image of the LCC device illuminated by the second light source. The apparatus also includes a processor for comparing the first and second images to identify exposed copper on the LCC device.

The apparatus may further include a diffuser facing a rear surface of the LCC device. The diffuser diffuses substantially all light of a first frequency but does not diffuse light of a second frequency. The apparatus further includes a first light source emitting light having the first frequency and a second light source emitting light having the second frequency. The apparatus therefore permits the LCC device to be backlit by the first light source and front lit by the second light source.

### BRIEF DESCRIPTION OF THE DRAWINGS

FIG. 1 is a side view of an LCC device inspection module embodying the present invention.

FIG. 2 is a view taken along line 2-2 in FIG. 1.

FIG. 3 is a front view of a bank of lights of the module.

FIG. 4 is an exploded view of the module.

FIG. 5 is a section view along line 5-5 in FIG. 2.

FIG. 6 is a bottom perspective view of a side mirror assembly of the module.

FIG. 7 is a partially broken bottom view of the side mirror assembly in FIG. 6.

FIG. 8 is a view taken along line 8-8 in FIG. 7.

FIG. 9 is a section view taken along line 9-9 in FIG. 7.

FIG. 10 is a top perspective view of a mirror and a diffuser of the side mirror assembly.

FIG. 11 is a side view of an alternative construction of an LCC device inspection module.

### DETAILED DESCRIPTION

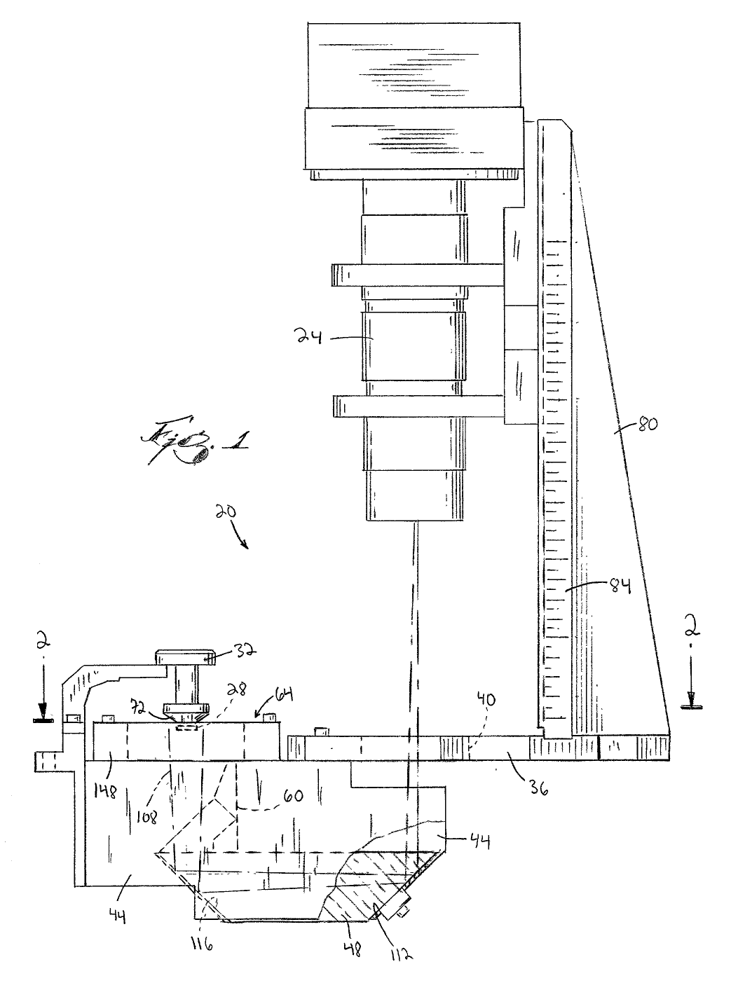

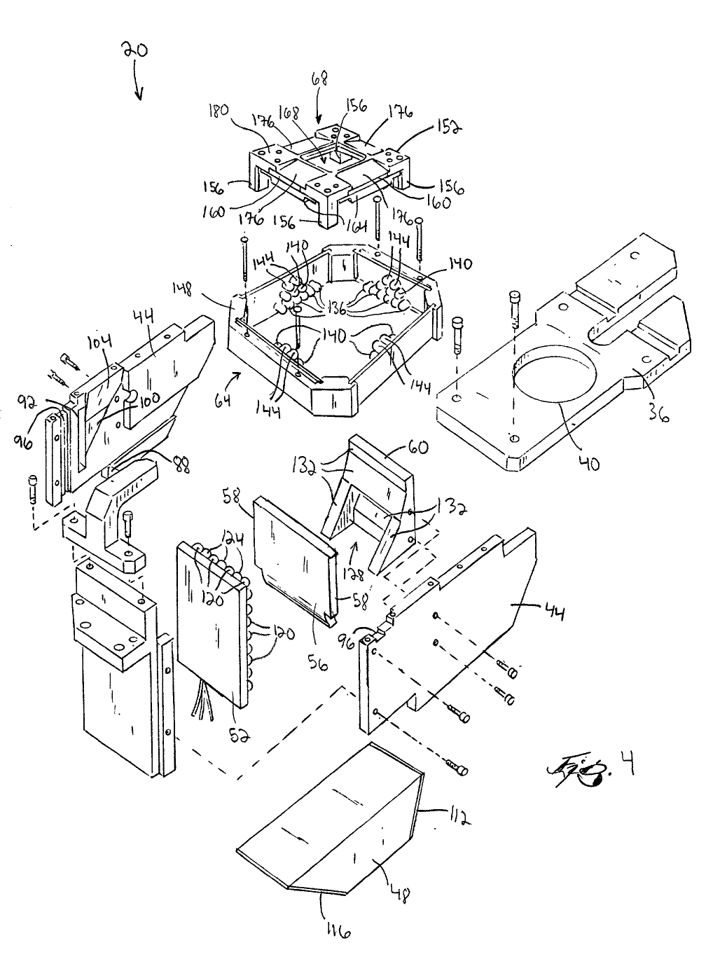

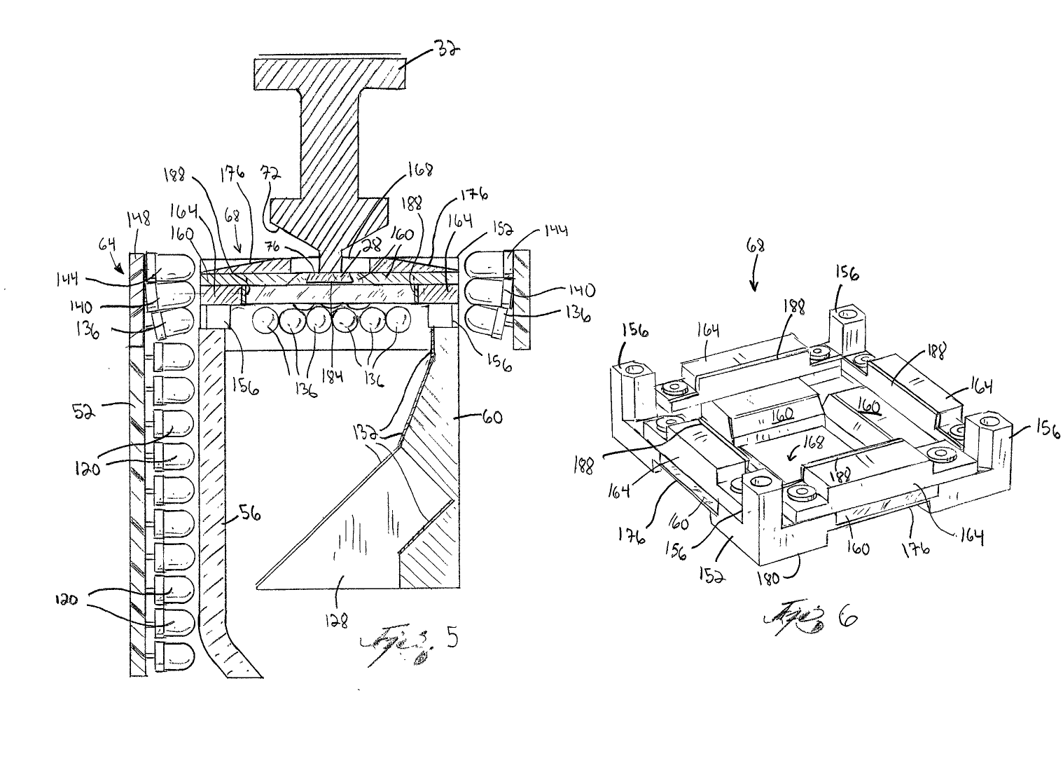

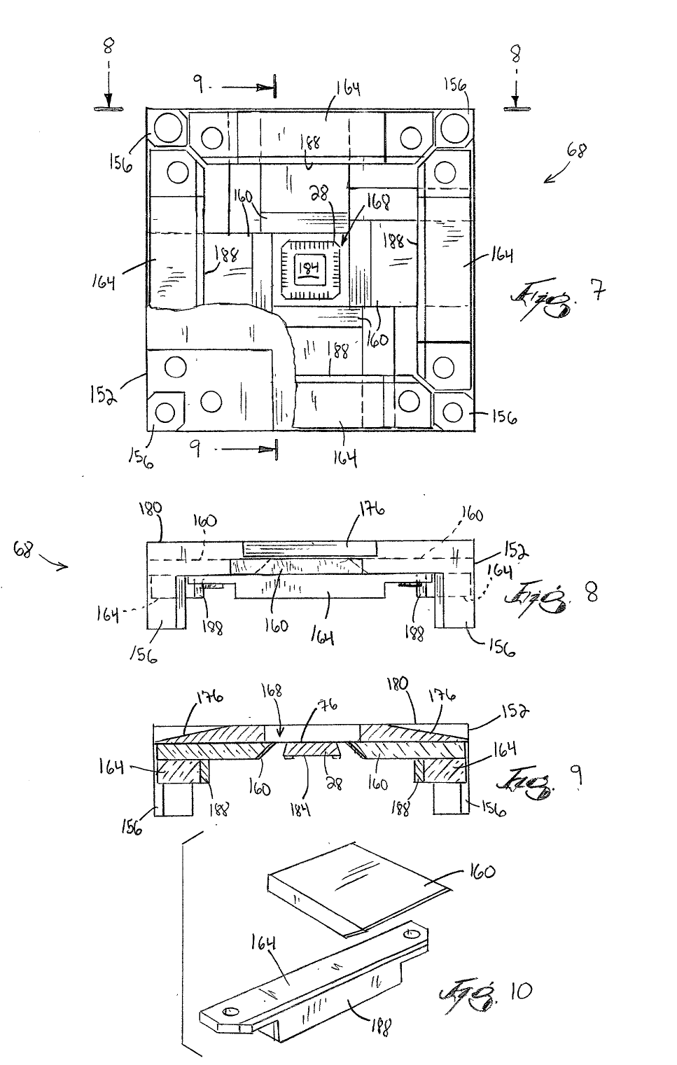

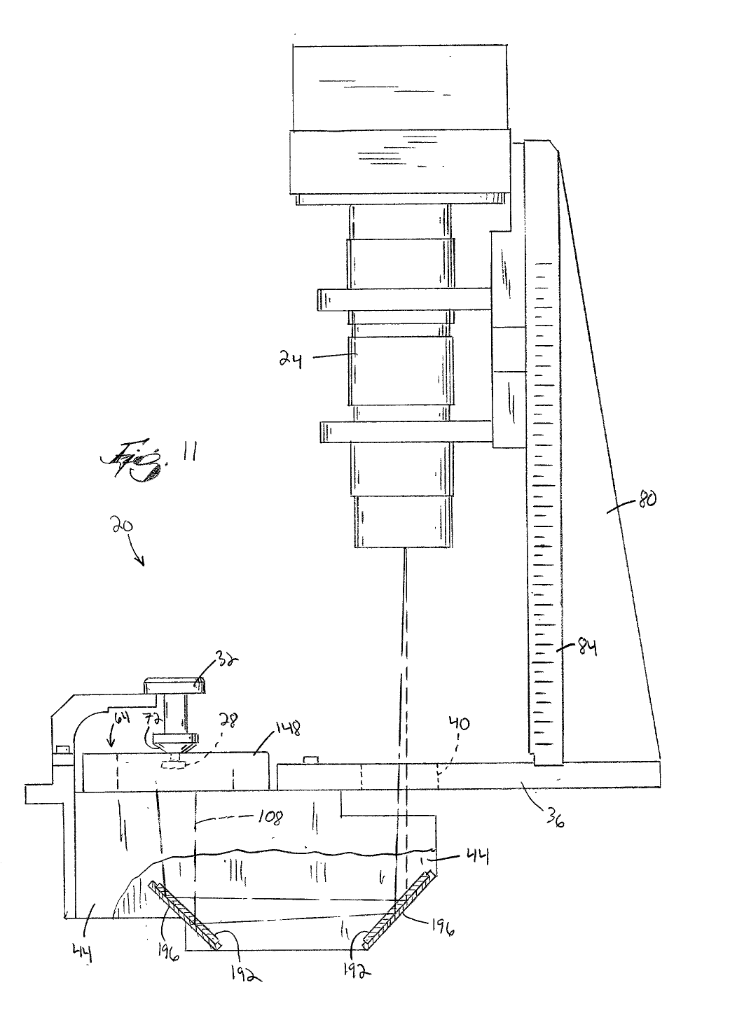

With reference to FIGS. 1-10, the present invention provides an LCC device inspection module 20 and a camera 24 used for viewing an LCC device 28 that is supported by a vacuum pick-and-place nozzle 32 in the inspection module 20. The module 20 includes a camera mounting structure 36 having an aperture 40 therein through which the camera 24 can view the LCC device 28, side plates 44 mounted to and beneath the camera mounting structure 36, a prism 48, a bank of lights 52 (FIGS. 3-5) arranged in a two-dimensional array, a translucent diffuser 56 having projections 58, a reflector 60, a ring of lights 64, a side mirror assembly 68 and a reflective diffuser 72 (FIGS. 1 and 5) connected to the vacuum pick-and-place nozzle 32 and facing a rear surface 76 of the LCC device 28.

The term “diffuser” as used herein means an apparatus that converts light emitted in a specific direction from a specific source into diffuse light that is not perceived to originate from any specific source. The term “translucent diffuser” as used herein means a diffuser that allows light to pass through it and diffuses the light as it emerges from the diffuser. The term “reflective diffuser” as used herein means a diffuser that reflects and diffuses light. Diffusers may be further categorized by the frequencies of light they diffuse. For example, a white translucent diffuser diffuses all frequencies while green translucent diffusers and red translucent diffusers diffuse only green and red lights, respectively.

As seen in FIG. 1, the camera mounting structure 36 includes an upright bracket 80 to which the camera 24 is adjustably mounted and a ruler 84 to assist in proper vertical adjustment of the camera 24.

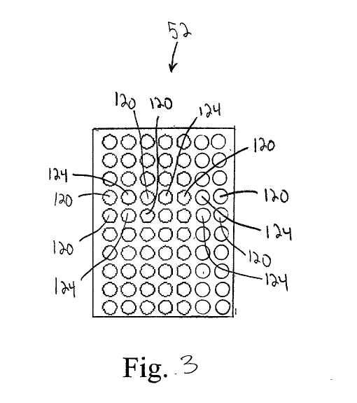

With reference to FIG. 4, the side plates 44 are substantially mirror-images of each other. Each side plate 44 includes a prism support 88 for supporting the prism 48, a blind supporting aperture 92 defined partially through the side plate 44 and into which one of the projections 58 of the diffuser 56 inserts to secure the diffuser 56 to the side plate 44, a recess 96 that captures side surfaces of the bank of lights 52, and a reflective surface 100 for reflecting light. An upper portion 104 of the reflective surface 100 is angled inwardly, the significance of which will be discussed in greater detail below.

The prism 48 is preferably a dove prism, but may be any type of prism and still be within the spirit and scope of the present invention. The camera 24 includes a line of sight 108 (see FIG. 1) and is positioned above a first angled edge 112 of the prism 48. The line of sight 108 is a path along which the camera views the LCC device 28 and, more particularly, the line of sight 108 is a last leg of the path. With reference to FIG. 1, the line of sight 108 is between a second angled edge 116 of the prism 14 and the LCC device 28. The LCC device 28 is positioned above the second angled edge 116 of the prism 48. By virtue of the prism 48, the camera 24 may view the LCC device 28 from a position other than directly underneath the LCC device 28, which is beneficial due to the space limitations in many machine vision systems.

With reference to FIG. 3, the bank of lights 52 preferably includes first and second sets of LED's 120, 124 having first and second frequencies, respectively (e.g., red and blue). Preferably, the LED's 120, 124 are arranged in alternating columns such that, in each row, each LED 120 has an LED 124 on either side of it, and vice versa.

With reference to FIGS. 4 and 5, the diffuser 56 diffuses light emitted from the bank of lights 52. The diffuser 56 creates a “cloudy-day” illumination condition that is typically used in machine vision systems. Cloudy-day lighting is a term used frequently within the machine vision community, and it refers to the type of lighting experienced on a cloudy or hazy day. This type of lighting requires diffuse light coming from a broad area. The breadth of the area from which the light is provided is commonly described in terms of a sphere or a substantial hemisphere. It is often sufficient to use the substantial hemisphere of diffuse light for machine vision applications. In the illustrated construction, the diffuser 56 is a piece of white plastic and it may therefore be termed a whit translucent diffuser, however, other materials may be used. The light emitted by the first and second sets of LED's 120, 124 evenly illuminates the diffuser 56.

With continued reference to FIGS. 4 and 5, the reflector 60 is mounted between the side plates 44 and includes an opening 128 positioned over the second angled edge 116 of the prism 48 to allow the camera 24 to view the LCC device 28 along the line of sight 108. The reflector 60 also includes a plurality of reflective surfaces 132 that reflect the diffuse light emitted by the bank of lights 52 through the diffuser 56. The reflective surfaces 100, 104, 132 are oriented to create a substantial hemisphere of cloudy-day light around the LCC device 28. Thus, the light from the first and second sets of LED's 120, 124 meet both the “diffuse” and “broad area” requirements for creating a cloudy-day lighting condition. Light emitted by the bank of lights 52 through the diffuser 56 does not contact the LCC device 28 along the line of sight 108 due to the opening 128 and the lack of reflective surfaces therein for reflecting the light emitted from the bank of lights 52 along the line of sight 108. Narrow cracks in the front surface of the LCC device 28 are visible as shadows because the light does not shine perpendicular to the front surface and therefore cannot penetrate into and illuminate the crack. This type of lighting is therefore useful for identifying narrow cracks in the LCC device 28.

With reference to FIGS. 1, 2, 4 and 5, the ring of lights 64 is mounted to the top of the side plates 44 and preferably includes first, second, and third sets of LED's 136, 140, 144. The first set of LED's 136 emits a first frequency of light (preferably in the orange to red spectrum) and the second and third sets of LED's 140, 144 emit a second frequency of light (preferably in the blue to green spectrum). However, the second and third set of LED's 140, 144 may emit different frequencies of light, for example, the second set of LED's 140 may be in the blue spectrum and the third set of LED's 144 may be in the green spectrum, and vice versa. The first, second and third sets of LED's 136, 140, 144 are supported by a generally square or rectangular-shaped frame 148 and are positioned on all four sides of the frame 148. Each set of LED's may include more or fewer LED's and may be positioned on fewer sides of the frame and still be within the spirit and scope of the present invention.

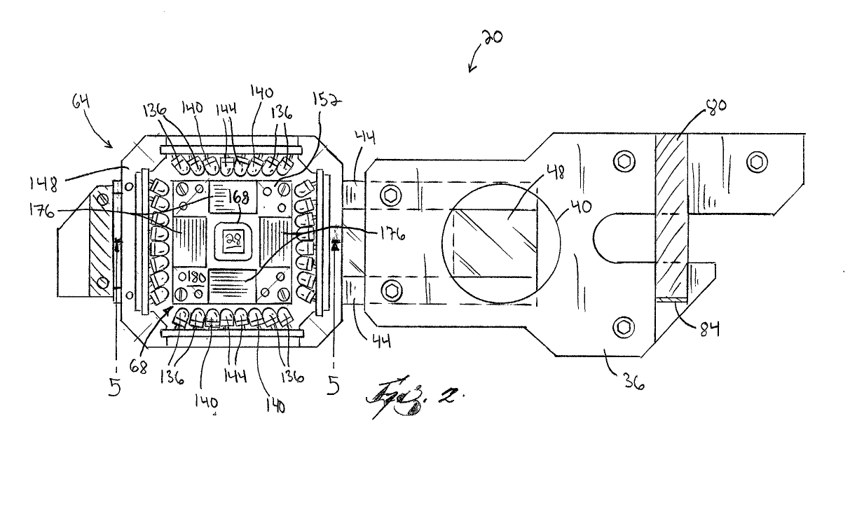

With reference to FIGS. 2 and 4-10, the mirror assembly 68 is mounted within the ring of lights 64 and includes a mirror block 152 having a plurality of legs 156 for mounting the mirror block 152 to the side plates 44, a plurality of mirrors 160 and a plurality of diffusers 164. The mirror block 152 includes an aperture 168 in which the LCC device 28 is inserted through for inspection purposes and a plurality of mirror recesses in which the plurality of mirrors 160 are supported within. The mirror block 152 also includes a plurality of ramped surfaces 176 on a top surface 180 of the mirror block 152 to divert light from the third set of LED's 144 toward the reflective diffuser 72 (the significance of which is discussed in greater detail below). One of the plurality of mirrors 160 is positioned on each side of the aperture 168. By virtue of the prism 48 and the plurality of mirrors 160, the camera 24 may view a front surface 184 and all four sides of the LCC device 28 in a single image. Each diffuser 164 is positioned on one of the four sides of the aperture 168 and includes a colored plate 188. The diffuser 164 is a white translucent diffuser and the colored plate 188 is a translucent diffuser of the frequency emitted by the second set of LED's 140. Alternatively, the diffuser 164 could be of the same frequency as the second set of LED's 140 and the colored plate 188 could then be illuminated.

With reference to FIGS. 2, 4 and 5, operation of the module 20 will first be discussed with respect to detection of surface defects. Surface defects that can occur on the front surface 184 of the LCC device during manufacturing may include scratches, cracks, foreign material, and contamination. Surface defects can cause the LCC device 28 to malfunction or otherwise be inoperative. Dark field illumination or off-axis lighting (light rays hitting the device at a very low angle) may be used to detect surface defects on the LCC device 28. In the illustrated construction, the off-axis lighting is provided by the first set of LED's 136, which emit light generally parallel to the front surface 184 and generally perpendicular to the line of sight 108 of the camera 24. The light emitted by the first set of LED's 136 is preferably of a different frequency (e.g., red light) than the light emitted by the second and third sets of LED's 140, 144. The light from the first set of LED's 136 passes between the legs 156 of the mirror block 152, underneath the plurality of mirrors 160 and diffusers 164, and illuminates the front surface 184 of the LCC device 28 at a low angle. By illuminating the LCC device 28 with such low angle lighting, the flat portion of the front surface 184 appears to be a uniform color, pits appear as dark areas having light peripheries, and protrusions appear as lighter colored areas on the front surface 184.

The module 20 can also detect exposed copper on the LCC device 28. LCC devices typically have copper pads on their front surfaces for contacting printed circuit boards. The copper pads should be completely covered with solder, which allows the LCC device to be mounted to the printed circuit boards. If there is a lack of solder covering the copper pads, the device may not properly mount to printed circuit boards and the copper pads may not have an electrically functional contact with the printed circuit boards.

Referring to FIGS. 3-5, the first set of LED's 120 (e.g., red LED's) from the bank of lights 52 emits light of the first frequency (e.g., red as illustrated), which is reflected by exposed copper on the front surface 184 of the LCC device 28. The camera 24 views a first image of the LCC device 28 when the first set of LED's 120 is illuminated. The first set of LED's 120 are turned off and the second set of LED's 124 (e.g., blue LED's) from the bank of lights 52 are turned on and emit light of the second frequency (e.g., blue as illustrated), which is not reflected by exposed copper to the extent of the light with the first frequency. Without moving the LCC device, the camera 24 views a second image of the LCC device 28 when the second set of LED's 140 is illuminated. The module 20 further includes a processor that compares the first and second images of the LCC device 28 to identify exposed copper on the LCC device 28. The first and second images are registered with each other because neither the camera nor the LCC device is moved. The processor subtracts the second image from the first image (e.g., pixel by pixel) to create a third image that substantially only includes exposed copper. If there is exposed copper on the LCC device 28, it will appear in the third image.

The module 20 can also backlight the LCC device 28 to permit inspection of the periphery of the LCC device 28. The module 20 can also backlight all four sides of the LCC device 28 to permit inspection of the periphery of all four sides. The LCC device and sides appear in silhouette when backlit. Backlighting therefor provides a sharp image of the peripheries of the LCC device 28 and all four sides. Defects such as chipped or broken edges and burrs protruding from the edges of the LCC device 28 are therefore best seen when the LCC device is backlit. It is also easiest and most accurate to measure 2D aspects (e.g., length and width) of the LCC device 28 when it is backlit.

Referring again to FIGS. 1, 2 and 4-10, the second and third sets of LED's 140, 144 emit light to backlight the LCC device 28. No other sets of LED's emit light during the backlighting operation. The third set of LED's 144 is preferably angled toward the reflective diffuser 72 on the nozzle 32 and emits light over the top surface 180 of the mirror block 152 and along the ramped surfaces 176 toward the reflective diffuser 72. The light reflected by the reflective diffuser 72 backlights or silhouettes the LCC device 28 for the camera 24 so that the camera 24 sees a silhouetted plan view of the front surface 184 of the LCC device 28. In the illustrated construction, the reflective diffuser 72 is green and the frequency of light emitted by the third set of LED's 144 is green, however, the reflective diffuser 72 and the frequency of the light emitted by the third set of LED's 144 may be any color or frequency, respectively, and still be within the spirit and scope of the present invention.

The second set of LED's 140 emits light for the purpose of backlighting the four sides of the LCC device 28. The light from the second set of LED's 140 passes through the plurality of diffusers 164 and colored plates 188 to illuminate the colored plates 188 and backlight or silhouette the sides of the LCC device 28 for the camera 24. In the illustrated construction, the colored plates 188 are green and the frequency of light emitted by the second set of LED's 140 is green, however, the colored plates 188 and the frequency of the light emitted by the second set of LED's 140 may be any color or frequency, respectively, and still be within the spirit and scope of the present invention. The plurality of mirrors 160 are angled so that the camera 24 sees the sides of the LCC device 28 backlit by the colored plates 188 in the mirrors 160.

With reference to FIG. 11, the module 20 includes a plurality of reflective surfaces or viewing mirrors 192 in place of the prism 48. The mirrors 192 are supported by mirror supports 196. The module 20 can include any number of viewing mirrors 192 necessary for the camera 24 to view the LCC device 28 to provide flexibility for positioning the camera 24 with respect to the module 20.

Although particular constructions of the present invention have been shown and described, other alternative constructions will be apparent to those skilled in the art and are within the intended scope of the present invention.

1. An apparatus for inspecting an LCC device, the apparatus comprising:
an LCC support mechanism adapted to support the LCC device;
a camera positioned in spaced relation to the LCC support mechanism to view the LCC device along a line of sight; and
a light source emitting light to illuminate the LCC device in a substantial hemisphere of light except along the line of sight.

2. The apparatus as claimed in claim 1, wherein the light source includes a plurality of LED's.

3. The apparatus as claimed in claim 1, further comprising at least one reflective surface for reflecting light from the light source to create the substantial hemisphere of light.

4. The apparatus as claimed in claim 3, wherein the light source includes a plurality of LED's and the apparatus further comprises a light diffuser interposed between the at least one reflective surface and the LED's such that light emitted from the LED's passes through the diffuser prior to reaching the reflective surface and the LCC device.

5. The apparatus as claimed in claim 3, wherein the light reflected off of the at least one reflective surface simulates cloudy day illumination.

6. The apparatus as claimed in claim 1, further comprising a camera reflective surface defining the camera line of sight.

7. The apparatus as claimed in claim 6, wherein the camera reflective surface includes a prism.

8. The apparatus as claimed in claim 6, wherein the camera reflective surface includes at least one mirror.

9. The apparatus as claimed in claim 6, wherein the camera reflective surface includes a plurality of mirrors.

10. The apparatus as claimed in claim 1, further comprising a second light source emitting light at a low angle with respect to the LCC device to provide dark field illumination of the LCC device.

11. The apparatus as claimed in claim 10, wherein the second light source emits light generally perpendicular to the line of sight.

12. An apparatus for detecting exposed copper on an LCC device, the apparatus comprising:
an LCC support mechanism adapted to support the LCC device;
a first light source emitting a first frequency of light that is reflected by copper;
a second light source emitting a second frequency of light that is not reflected by copper to the extent of the first frequency;
a camera positioned to view a first image of the LCC device illuminated by the first light source, and to view a second image of the LCC device illuminated by the second light source; and
a processor for comparing the first and second images to identify exposed copper in the LCC device.

13. The apparatus as claimed in claim 12, wherein the first light source includes a plurality of light emitting diodes emitting light in a red to orange light spectrum, and the second light source includes a plurality of light emitting diodes emitting light in a light spectrum other than the red to orange light spectrum.

14. The apparatus as claimed in claim 12, wherein the processor includes means for subtracting the second image from the first image, wherein the means for subtracting the second image from the first image creates a third image, the third image including substantially only the exposed copper of the LCC device.

15. The apparatus as claimed in claim 12, further comprising at least one reflective surface, wherein the camera is positioned to view the respective first and second images of the LCC device reflected off the at least one reflective surface.

16. The apparatus as claimed in claim 15, wherein the reflective surface includes a prism.

17. The apparatus as claimed in claim 15, wherein the reflective surface includes at least one mirror.

18. The apparatus as claimed in claim 15, wherein the reflective surface includes a plurality of mirrors.

19. The apparatus as claimed in claim 12, further comprising a light diffuser for diffusing both the first and second frequencies to create cloudy day illumination of the LCC device.

20. A method for detecting exposed copper in an LCC device, the method comprising the steps of:
supporting an LCC device in a fixed location;
illuminating the LCC device with light of a first frequency that is reflected by copper;
capturing a first image of the LCC device while the LCC device is illuminated by the first frequency light;
illuminating the LCC device with light of a second frequency that is not reflected by copper to the extent that the first frequency is reflected;
capturing a second image of the LCC device while the LCC device is illuminated by the second frequency light;
registering the first and second images; and
subtracting the second image from the first image to obtain a third image showing the regions of exposed copper in the LCC device.

21. The method of claim 20, wherein both capturing steps include viewing the LCC device along a line of sight with a camera and capturing the respective images with the camera; and wherein both illuminating steps include diffusing the respective first and second lights to illuminate the LCC device with cloudy day lighting except along the line of sight.

22. The method of claim 20, wherein both capturing steps include viewing the LCC device along a line of sight with a camera and capturing the respective images with the camera; and wherein both illuminating steps include reflecting respective first and second lights with reflective surfaces to surround the LCC device with a substantial hemisphere of light except along the line of sight.

23. An apparatus for inspecting an LCC device having a front surface and a rear surface, the apparatus comprising:
an LCC support member adapted to support the LCC device by the rear surface;
a camera positioned to view the front surface of the LCC device;
a first diffuser facing the rear surface of the LCC device, the first diffuser diffusing light of a first frequency toward the rear surface of the LCC device, the first diffuser not diffusing light of a second frequency;
a first light source emitting light having the first frequency toward the first diffuser to backlight the LCC device with diffuse light with respect to the camera when the first light source is illuminated; and
a second light source emitting light having the second frequency toward the front of the LCC device to front light the LCC device without backlighting the LCC device.

24. The apparatus of claim 23, wherein the first diffuser is a reflective diffuser that both reflects and diffuses light of the first frequency.

25. The apparatus of claim 24, wherein the reflective diffuser surrounds the support member.

26. The apparatus of claim 24, wherein the reflective diffuser is generally frusto-conical in shape.

27. The apparatus of claim 23, wherein the support member includes a vacuum nozzle.

28. The apparatus as claimed in claim 23, wherein the first and second light sources respectively include a plurality of green LED's and a plurality of red LED's, and wherein the first diffuser is a green light diffuser.

29. The apparatus as claimed in claim 23, further comprising a second diffuser diffusing light of the second frequency to illuminate the front of the LCC device with cloudy day lighting of the second frequency.

30. The apparatus of claim 29, wherein the second diffuser is a translucent diffuser positioned generally between the second light source and the LCC device.

31. The apparatus as claimed in 23, wherein the LCC device includes side surfaces, the apparatus further comprising a side reflective surface and a background light diffuser, the camera being positioned to view at least one side surface of the LCC device in front of the background diffuser such that the side surface is backlit in the side reflective surface as seen by the camera when the background diffuser is illuminated.

32. The apparatus of claim 31, wherein the background diffuser is a translucent diffuser, and the apparatus further comprising a light source selectively emitting light through the background diffuser to backlight the side surface of the LCC device.
